(19) United States
(12) Patent Application Publication
(10) Pub. No.: US 2019/0013684 A1
(43) Pub. Date: Jan. 10, 2019

(54) PORTABLE ELECTRONIC DEVICE CHARGING APPARATUS AND HOLDING MEANS THEREFOR

(71) Applicant: PURSETTO, INC., San Diego, CA (US)

(72) Inventor: William GLENN, San Diego, CA (US)

(73) Assignee: PURSETTO, INC., San Diego, CA (US)

(21) Appl. No.: 16/025,886

(22) Filed: Jul. 2, 2018

Related U.S. Application Data
(60) Provisional application No. 62/528,471, filed on Jul. 4, 2017.

(51) Int. Cl. H02J 7/00

(52) U.S. Cl. CPC H02J 7/0045; H02J 7/025

(57) ABSTRACT

A portable apparatus for temporarily holding personal items and providing a charger for electronic devices. The battery in the charger may be wirelessly recharged or recharged by being connected to a source of electrical energy.

### FIELD OF INVENTION

This invention relates generally to portable apparatus for charging electronic devices and more particularly to holding racks for such devices and other items.

### BACKGROUND OF THE INVENTION

Currently there are a number of solutions for portable device charging. Some of these solutions enable charging of portable electronic devices but these solutions typically fail to meet the needs of the industry because they are inconvenient, heavy, and do not provide a storage solution for personal belongings. Other solutions attempt to allow for hanging of belongings on the edge of a table with a portable hook, but these solutions are similarly unable to meet the needs of the industry because they do not fit on all tables, do not hold multiple items, and are unable to charge portable electronic devices. Still other solutions seek to hold personal belonging by placing them on a stand, but these solutions also fail to meet industry needs because they do not provide portable electronic device charging functions.

### SUMMARY OF EMBODIMENTS OF THE INVENTION

This concept solves the above-identified deficiencies by providing a portable, stand-alone rack for holding one or more personal items, including electronic devices, and providing convenient means for electronically charging such electronic devices.

Described here is a device that holds personal items, such as a purse or shopping bags, which device can be placed at a convenient location, such as next to a restaurant table while the user is dining, or while in a waiting room or transportation terminal. This same device can provide for charging portable electronic devices such as a phone or tablet without the need to be plugged into a wall outlet. For further convenience the device has an internal battery that can be recharged by any practical means.

The apparatus would normally include an upright structure or post with stable means to stand on a floor or on the ground. A particularly stable configuration is three generally equiangular legs extending outwardly from the upright structure. The upper position of the upright structure would typically have one or more hooks from which items such as purses, shopping bags, or electronic devices to be charged, may be hung.

There are other configurations that are within the scope of this concept, which will be described in detail below.

### BRIEF DESCRIPTION OF THE DRAWING

The objects, features, and advantages of this concept will be more fully understood from the following detailed descriptions, when read in conjunction with the accompanying drawings, in which:

FIG. 1 is a perspective view of an embodiment of the invention;

FIG. 2 is an elevational view of the FIG. 1 structure;

FIG. 3 is a perspective, partially exploded, schematic view of an embodiment similar to FIG. 1, showing basic elements of a wireless charging assembly;

FIG. 4 is an exploded perspective view of a charger which may be used with the FIG. 1 embodiment;

FIG. 5 is a perspective view of an apparatus for charging the battery portion of the FIG. 4 electronic device charger;

FIG. 6 is a perspective view of the apparatus of FIG. 1 with examples of how it can be used;

FIG. 7 is a perspective view of an alternative embodiment of the invention;

FIG. 8 is a perspective view of another alternative of the invention; and

FIG. 9 is a perspective view of the embodiment of FIG. 8 showing the apparatus in use.

### DETAILED DESCRIPTION OF EMBODIMENTS OF THE INVENTION

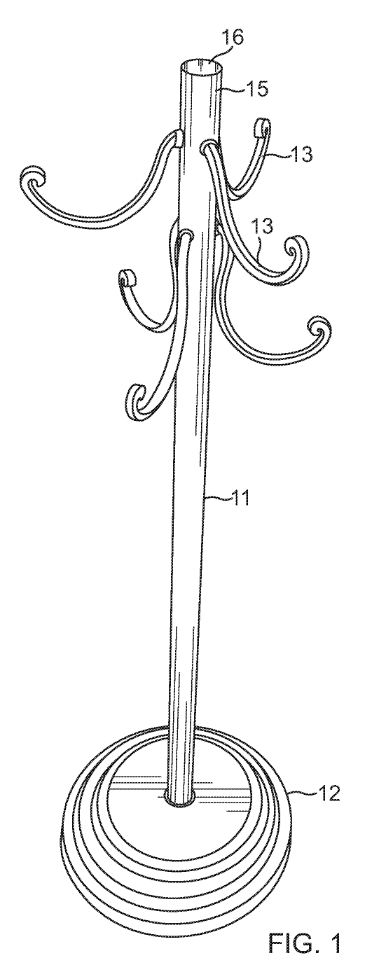

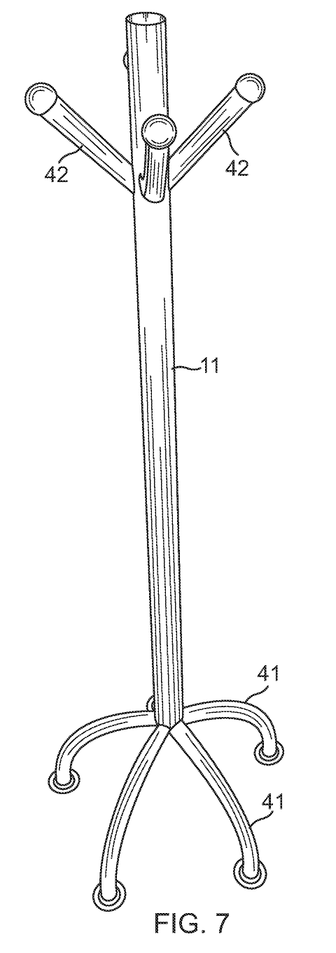

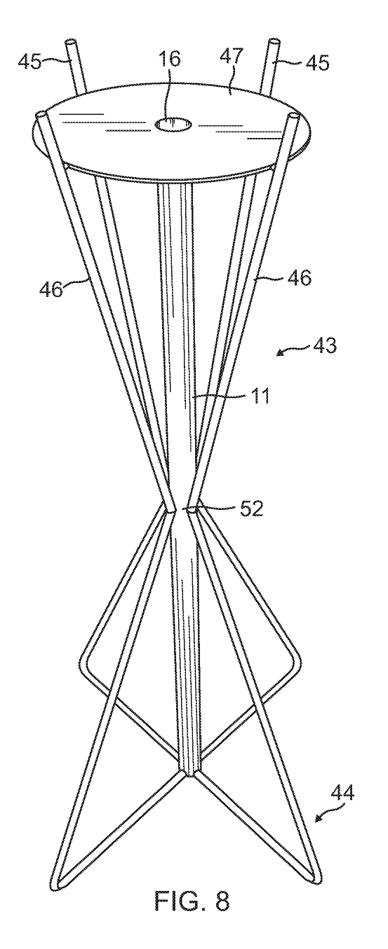

As used herein, the term “stand” will be understood to include any structure or element that engages the floor or ground and supports an upright or vertical structure. The stand may the circular element 12 in FIG. 1, three or more legs 41 in FIG. 7, or the bottom of wire apparatus 44 in FIG. 8.

The term “upright structure” as used herein, will be understood to include post 11 in FIGS. 1, 7, and 8, and the wire structure of FIG. 8 above the stand.

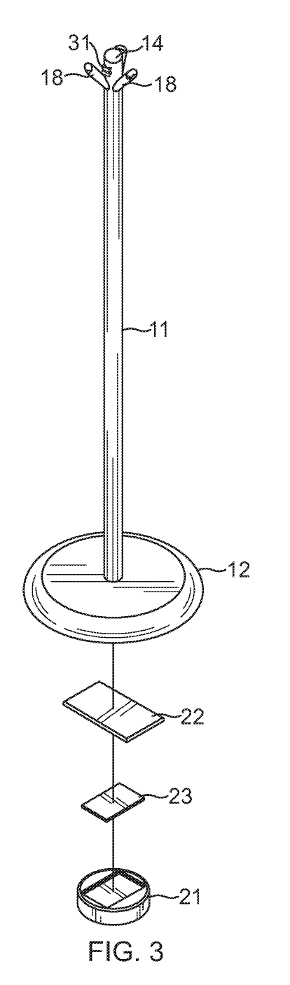

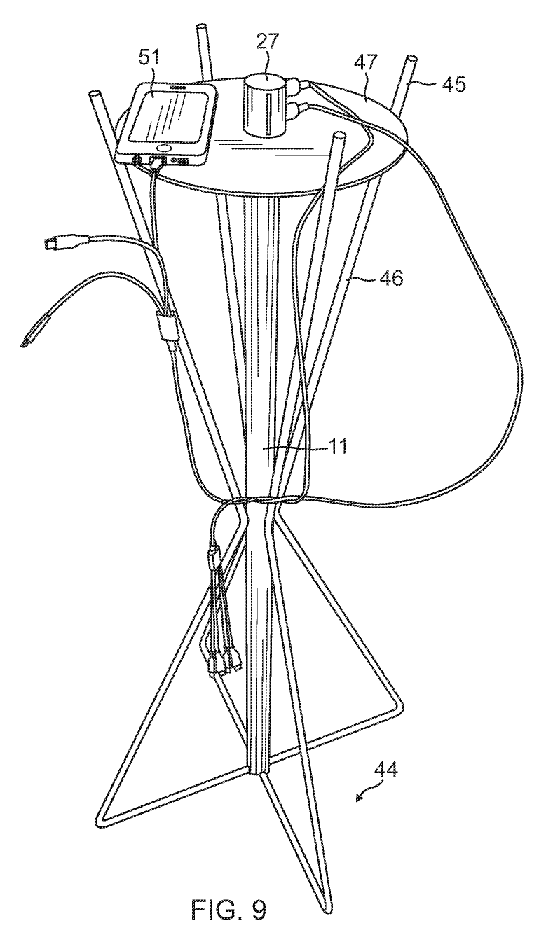

The terms “hook” or “spokes” will be understood to mean the shaped hook elements 13 of FIG. 1, the shorter straight spokes 35 of FIGS. 3 and 7, and the upwardly extending wire rods 45 as the top portions of the wire structure of FIGS. 8 and 9.

These definitions are provided for convenience and to facilitate understanding. They are shown and used as examples only and are not to be understood as limitations as to structures that are reasonable equivalents.

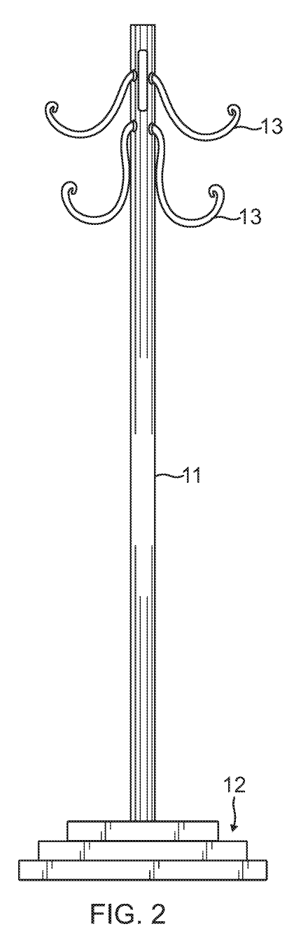

With reference to the drawings, and more particularly to FIGS. 1-4 thereof, upright structure or post 11 extends upwardly from stand 12. The stand is shown here as a round element which engages a floor and maintains post 11 in an upright orientation, as shown. The stand may be comprised of one or more circular elements, three being shown here in step form.

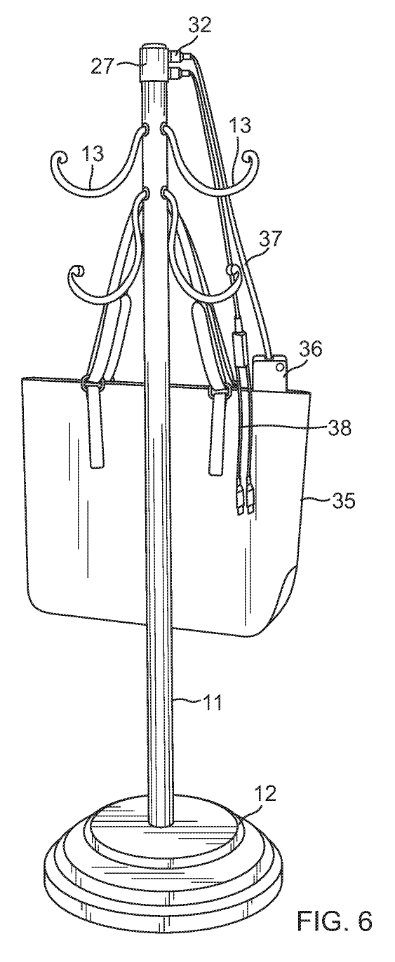

The top portion of post 11 is configured with one or more spokes or hooks 13 from which items may be hung. Such items may include purses, shopping bags, electronic devices to be charged, and items of clothing, among others as exemplified in FIGS. 6 and 9. The hooks need not be at or near the top of the post, nor need they be at one linear location on the post. Hooks may be located at any practical height above the base, and may be at various heights above the floor, and at various angular positions on the post.

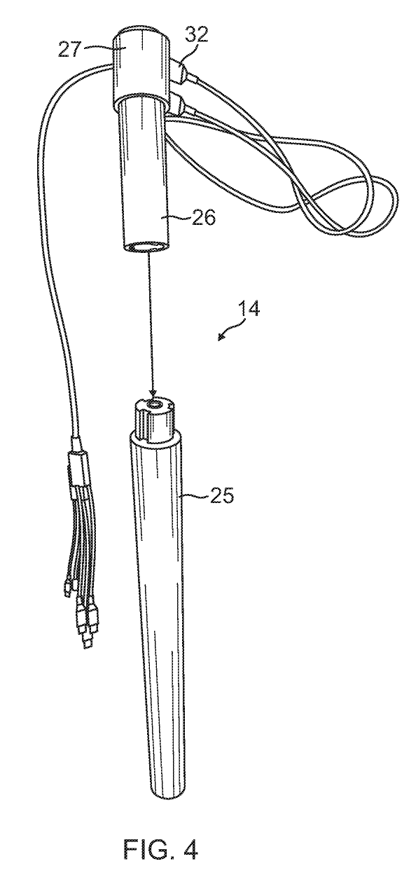

Top end 15 of post 11 is shown hollow 16, to receive charger 14, as seen in FIG. 4. The electronic device charger will be described below.

FIG. 3 shows how a structure, similar to FIG. 1 but with incidentally different and simpler hooks 18, might employ a wireless charging system to recharge the electronic device charger 14.

Charging ports 31 are externally accessible from charger 14 for plugging in a cord or cable from an electronic device to be charged. These charging ports can be of standard shape, such as USB ports, for a cell phone or other digital device to be plugged into. Those ports could alternatively be of other configurations as may be required for many different devices.

A wireless charging transmitter 21, coupled with receiver 23 for charging battery 22, can be mounted within stand 12. Thus, this battery, from which electronic devices are charged, may itself be charged in a wireless manner. Battery 22 could also be located in charger 14 and be electronically connected to the wireless charging device in the base by any suitable means.

An alternative embodiment of the invention is shown in FIG. 7. Instead of a circular base, post 11 is supported by a plurality of legs 41. Three such legs provide a stable, practical stand, which easily accommodates an uneven floor or ground, but more than three legs can be employed, and five are shown. Further, hooks 42 are shaped differently from those shown in FIG. 1, showing that hooks of various shapes are contemplated, without practical limitation as to the number or shape of the hooks.

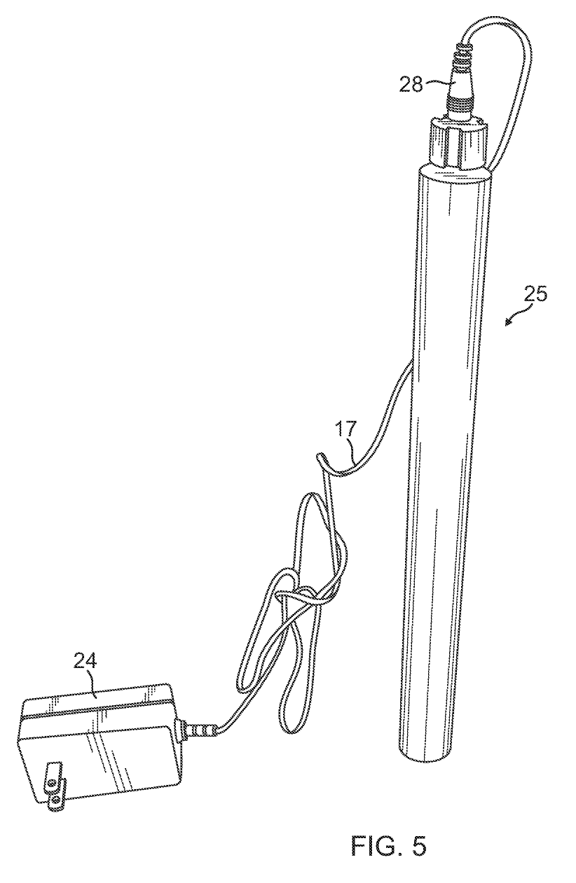

Electronic device charger 14 is shown in FIGS. 4 and 5. It is comprised of battery portion 25 and top portion 26, on which is head 27. FIG. 5 shows how battery portion 25 may be recharged by typical transformer 24, connected to typical plug 28 by cable 17. Top portion 26 of charger 14 has an internal male plug similar to the electrical connector portion of plug 28 which electronically connects head 27 to ports 31 (see FIG. 3) into which connectors 32 may be plugged.

FIG. 6 shows an example of how the FIGS. 1-4 apparatus can be used. A purse 35 may be hung on a hook 13. A cell phone 36 may reside in a side pocket of the purse and be recharged by means of cable 37 and connector 32 plugged into a receptacle 31 on charger head 27.

A typical use of the apparatus described herein might be at a restaurant, where the FIGS. 1 and 6 apparatus can be positioned unobtrusively adjacent to a person at a table, for example. Charger 14 is mounted in the hollow top portion of post 11. The diner's purse or other items could be hung from hook 13. Should cell phone charging become necessary, it is a simple matter to connect the phone 36 to head 27 of charger 14. Additional charging cables 38 are shown connected to head 27, ready to be connected with other electronic devices.

A different upright structure is shown in FIGS. 8 and 9. Here the stand, part of the upright structure, and the hooks are incorporated into a stiff wire structure 43. While the word “wire” is used, any material which satisfies the requirements as shown in these figures can be employed.

Post 11, hollow at the top, as previously shown, is supported within wire structure 43. The stand portion 44 may be a continuation of each wire 46. Also, the upper end of each wire provides a hook 45. Each wire 46 is secured, such as by welding or other suitable means, to platform 47. Open end 16 of post 11 is to receive charger 14, as before, and as shown in FIG. 9. In this case, a cell phone 51 can rest on platform 47 while being charged, or it may simply reside there while not in use.

As shown, only two wires 46, with appropriate bends, can constitute structure 43. Stand 44 could also be a separate wire structure and stand wire elements and the upper portions of the wires of structure 43 could be connected to post 11 at mid-point 52, such as by welding.

What is claimed is:

1. A free-standing multi-function apparatus comprising:
a stand for engagement with a floor or ground;
a structure extending upwardly from said stand;
at least one arm extending away from said structure in an outward direction and having at least a portion extending in a generally upward direction;
an electrical charger mounted to said structure, said electrical charger having at least one externally accessible port for receiving a charging cable connector from an electronic device, said electrical charger being coupled to a source of electrical energy.

2. The apparatus of claim 1, wherein said stand is a generally circular shaped dement having a generally flat bottom surface for engaging the floor or ground.

3. The apparatus of claim 1, wherein said stand comprises legs extending outwardly and downwardly from said upwardly extending structure for engaging the floor or ground.

4. The apparatus of claim 1, wherein said stand comprises stiff wire elements bent at the bottom to meet at a central location and configured for engaging the floor or ground.

5. The apparatus of claim 1, wherein said upwardly extending structure comprises a post which is hollow at least at its upper end.

6. The apparatus of claim 1, wherein said at least one arm comprises a hook-shaped element.

7. The apparatus of claim 1, wherein said at least one arm comprises a rod.

8. The apparatus of claim 4, wherein said at least one arm comprises an upward extension of at least one of said stiff wire elements.

9. The apparatus of claim 8, and further comprising a generally horizontal surface to which upper portions of said stiff wire elements are secured.

10. The apparatus of claim 1, wherein said electrical charger is removably mounted to the top of said structure.

11. The apparatus of claim 5, wherein said electrical charger is generally cylindrical rod shaped and configured to extend downwardly into said hollow upper end of said pole with said at least one externally accessible port extending outwardly from the top of said post.
